(19) United States
(12) Patent Application Publication
(10) Pub. No.: US 2023/0158913 A1
(43) Pub. Date: May 25, 2023

(54) VEHICLE POWER CONTROL DEVICE, POWER CONTROL METHOD, AND VEHICLE

(71) Applicant: TOYOTA JIDOSHA KABUSHIKI KAISHA, Toyota-shi (JP)

(72) Inventor: Yukinori MURAKAMI, Toyota-shi (JP)

(21) Appl. No.: 17/932,749

(22) Filed: Sep. 16, 2022

(30) Foreign Application Priority Data
Nov. 19, 2021 (JP) 2021-188841

(51) Int. Cl. B60L 53/51; B60L 53/60; H02J 7/35; H02J 7/00

(52) U.S. Cl. CPC B60L 53/51; B60L 53/60; H02J 7/35; H02J 7/007194; H02J 7/00712

(57) ABSTRACT

A power control device for use in a vehicle, comprising a solar panel; a first battery that is able to charge power generated by the solar panel; and A power output control unit for controlling the output destination of the power generated by the solar panel to either the first battery or the outside of the vehicle, The power output control unit is a power control device for a vehicle that outputs power generated by a solar panel to the outside of the vehicle when the first battery satisfies a predetermined condition.

### CROSS-REFERENCE TO RELATED APPLICATION

This application claims priority to Japanese Patent Application No. 2021-188841 filed on Nov. 19, 2021, incorporated herein by reference in its entirety.

### BACKGROUND

### 1. Technical Field

The present disclosure relates to a power control device mounted on a vehicle provided with a solar panel.

### 2. Description of Related Art

Japanese Unexamined Patent Application Publication No. 2018-038248 (JP 2018-038248 A) discloses a charging system in an electrified vehicle. The electrified vehicle includes a battery charging function using power generated by a solar panel and a battery charging function using power supplied from an external power source.

In the charging system described in JP 2018-038248 A, charging by the generated power of the solar panel for only a predetermined time from when the charging of a battery by the power supplied by the external power supply is completed is prohibited. Thus, an estimation accuracy of a full charge capacity of the battery based on an open-circuit voltage is suppressed from being decreased.

### SUMMARY

In the charging system described in JP 2018-038248 A, during a period in which the charging by the generated power of the solar panel is prohibited, it is not possible to charge the battery even when power is generated by the solar panel. Thus, power generated by the solar panel is wasted, and power is not utilized effectively.

The present disclosure provides a vehicle power control device that can effectively utilize power generated by a solar panel.

In one aspect of the disclosed technology, a vehicle power control device includes: a solar panel; a first battery that is able to charge power generated by the solar panel; and a power output control unit that controls an output destination of the power generated by the solar panel to either the first battery or an outside of a vehicle, in which when the first battery satisfies a predetermined condition, the power output control unit outputs the power generated by the solar panel to the outside of the vehicle.

According to the vehicle power control device of the present disclosure, when the first battery satisfies the predetermined condition, power generated by the solar panel is output to the outside of the vehicle. Therefore, power generated by the solar panel is effectively utilized.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram showing a schematic configuration of a power control device for a vehicle according to an embodiment of the present disclosure;

FIG. 2 is a processing flow chart of the power output control (first example) executed by the power output control unit; and

FIG. 3 is a processing flow chart of the power output control (second example) executed by the power output control unit

### DETAILED DESCRIPTION OF EMBODIMENTS

In the power control device for a vehicle equipped with a solar panel of the present disclosure, when the battery mounted on the vehicle becomes a state that cannot be charged, the power generated by the solar panel is output to a facility outside the vehicle or the like. By this output control, the power generated by the solar panel is effectively utilized. Hereinafter, an embodiment of the present disclosure will be described in detail with reference to the drawings.

### Embodiment

Configuration

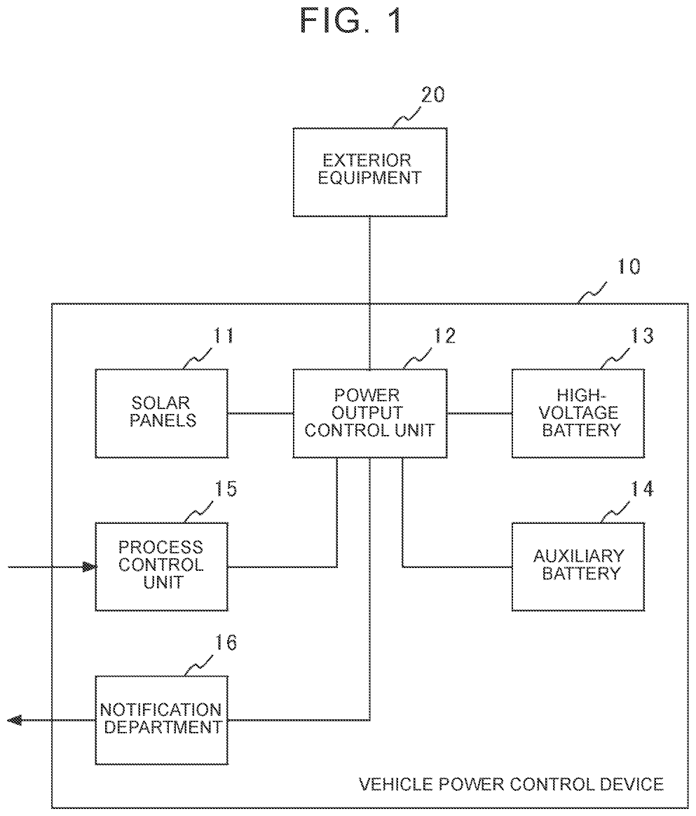

FIG. 1 is a functional block diagram showing a schematic configuration of a vehicle power control device 10 according to an embodiment of the present disclosure. The vehicle power control device 10 illustrated in FIG. 1 includes a solar panel 11, a power output control unit 12, a high-voltage battery 13, an auxiliary battery 14, a processing control unit 15, and a notification unit 16.

Vehicle power control device 10 according to the present embodiment can be mounted on a vehicle capable of performing Vehicle to Home (V2H) connecting. The V2H connection allows the vehicle to supply power stored, for example, in a high-voltage battery 13 for household use. In the present embodiment, the vehicle for mounting the vehicle power control device 10, by performing the outer-vehicle facility 20 and V2H connection, illustrating an example of supplying power from the vehicle power control device 10 to the outer-vehicle facility 20. Outer-vehicle facility 20, for example, a house or the like, is a facility that consumes power provided outside the vehicle.

The solar panel 11 is a power generation device that generates power by receiving the irradiation of sunlight. The solar panel 11 is a solar cell module that is typically an aggregate of solar cells. Power generated by the solar panel 11 is output to the power output control unit 12. The solar panel 11 may be installed, for example, in a roof of a vehicle.

The high-voltage battery 13 is a high-voltage battery (first battery) that supplies the power required to operate a device (not shown) such as a traveling motor associated with driving the vehicle. High-voltage battery 13, for example, such as a lithium battery or a nickel metal hydride battery, is constituted by a rechargeable battery. The high-voltage battery 13 is chargeable by the power generated by the solar panel 11 is connected to the power output control unit 12. As the high-voltage battery 13, a so-called driving battery can be exemplified.

The auxiliary battery 14 is a low-voltage battery (second battery) that provides the power necessary to operate equipment (not shown) such as headlamps and air conditioners, which are not involved in driving the vehicle. Auxiliary battery 14, for example, a lithium battery or a lead-acid battery, and is composed of a rechargeable battery. The auxiliary battery 14 is chargeable by the power generated by the solar panel 11 is connected to the power output control unit 12.

The power output control unit 12 is connected to a solar panel 11, a high-voltage battery 13, an auxiliary battery 14, a processing control unit 15, and a notification unit 16, respectively. Further, the power output control unit 12 can be electrically connected to the vehicle outer-vehicle facility 20. The power output control unit 12 includes a DCDC converter for performing power conversion or a relay circuit for switching the electrical connection/shut-off (not shown). The power output control unit 12 is an Electronic Control Unit (ECU) capable of controlling the output destination of the power generated by the solar panel 11.

Further, the power output control unit 12 monitors various states (voltage, current, storage rate, temperature, etc.) of the high-voltage battery 13. The power output control unit 12 controls the output destination of the power generated by the solar panel 11 based on State Of Charge (SOCs) and the temperature of the high-voltage battery 13. The output destinations of the generated power are a high-voltage battery 13, an outer-vehicle facility 20, and an auxiliary battery 14. The power output control unit 12 can acquire various states of the high-voltage battery 13 from information of various sensors (not shown) provided in the high-voltage battery 13. The power output control unit 12 also monitors the power generation state of the solar panel 11. The power output control unit 12 may determine whether or not the solar panel 11 is generating electric power that can be charged.

The power output control unit 12 typically includes a processor, a memory, an input/output interface, and the like. The above-described functions are realized by the processor reading and executing a program stored in the memory.

The processing control unit 15 is a functional unit capable of controlling execution of the power output control performed by the power output control unit 12 based on predetermined information. As the predetermined information, is instructed by an input from the user of the vehicle, etc., the storage rate of the high-voltage battery 13 (e.g., the storage rate based on the amount of charge required to travel a predetermined distance) and, the period of outputting power to the outer-vehicle facility 20 (e.g., time zone such as from 7 a.m. to 10 o'clock) information of the schedule indicating, also special situations (e.g., emergency such as power failure) it can be exemplified such as information indicating. The instruction from the user or the like may be directly input to the vehicle or may be input to the vehicle via a smart phone. Further, the schedule for outputting power to the outer-vehicle facility 20 may be set in advance for the vehicle. Also, information indicating a special situation, the vehicle power control device 10 can be obtained from the vehicle outer-vehicle facility 20.

Notifying unit 16 is a functional unit capable of notifying such contents of the control the power output control unit 12 is executed to the user of the vehicle. The content to be notified, for example, the amount of power generated by the solar panel 11 supplied to the home, such as the cost of power saved by the power supply, can be exemplified. The content of the notification is displayed on, for example, a screen of an in-vehicle navigation or a smartphone. The notification unit 16, in addition to notifying the contents of the control the power output control unit 12 is executed to the user or the like, may be a notification prompting the selection of the control from this power output control unit 12 executes to the user or the like.

Control

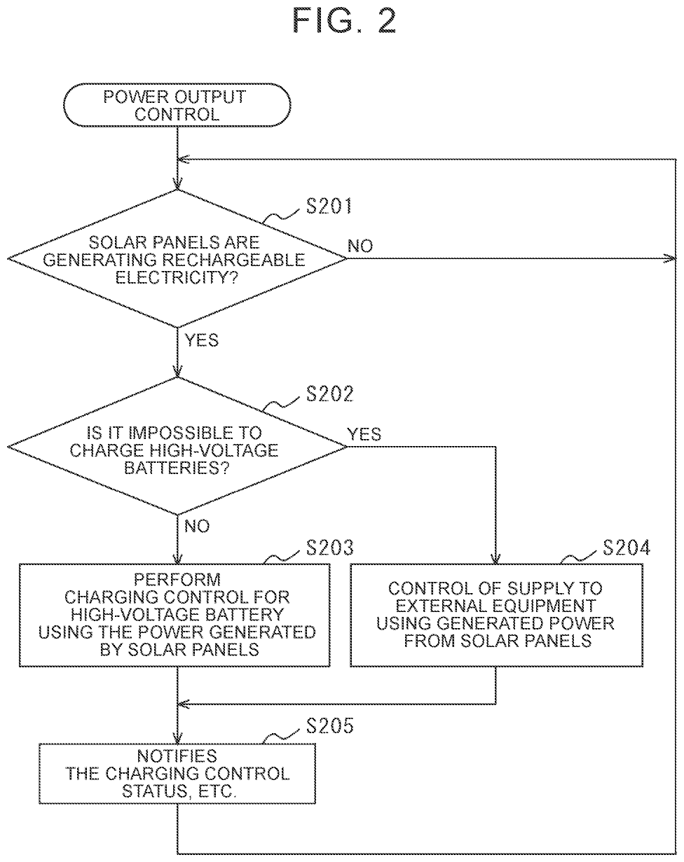

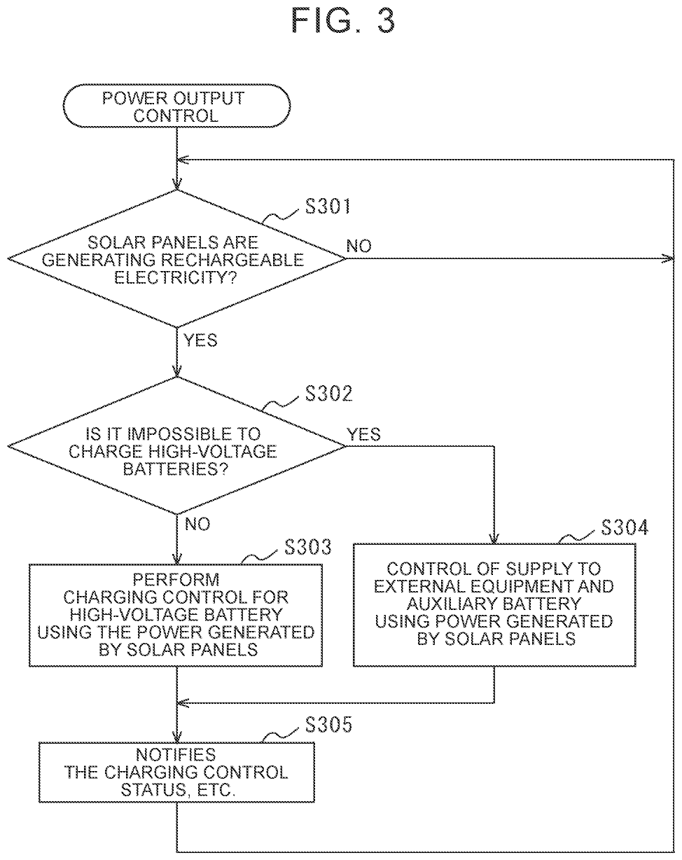

Next, with further reference to FIGS. 2 and 3, some control performed by the vehicle power control device 10 according to an embodiment of the present disclosure will be described. FIG. 2 is a flowchart illustrating the processing procedure of the first example of the power output control performed by the power output control unit 12 of the vehicle power control device 10. FIG. 3 is a flowchart illustrating the processing procedure of the second example of the power output control performed by the power output control unit 12 of the vehicle power control device 10.

1. Power Output Control of the First Example

Power output control process of the first example shown in FIG. 2 is executed when the vehicle power control device 10 (vehicle) is a state (V2H connection state) which is connected to the outer-vehicle facility 20 and the power supply possible.

### S201 of Steps

The power output control unit 12 determines whether or not the solar panel 11 is generating electric power that can be charged. Here, the power that can be charged, the device such as an ECU which requires operation for charging process and supply process, power more than power consumption is required to execute the charging process and supply process. If the power generated by the solar panel 11 is less than the power consumption of the device that executes the charging process or the supply process, the power is taken out from the battery (e.g., the auxiliary battery 14). In other words, rather the charging efficiency deteriorates.

If the solar panel 11 is generating power that can be charged (step S201, Yes), the process proceeds to step S202. On the other hand, if the solar panel 11 is not generating power that can be charged (step S201, no), the determination of the step S201 is repeated until the rechargeable power is generated.

### S202 of Steps

The power output control unit 12 determines whether or not the high-voltage battery 13 satisfies a predetermined condition. Specifically, the power output control unit 12 determines whether or not the high-voltage battery 13 is in a state in which it is impossible to charge power. The state in which it is impossible to charge power to the high-voltage battery 13 is, for example, a state in which the storage rate of the high-voltage battery 13 is fully charged, a state in which the storage rate of the high-voltage battery 13 has reached the storage rate specified by the user of the vehicle or the like, or a state in which the charging action is stopped (or limited) due to the temperature of the high-voltage battery 13 being too high, or the like. This determination can be made based on various states acquired from the high-voltage battery 13 or instructions from the processing control unit 15. Therefore, the predetermined condition determined by the power output control unit 12 may be a condition that the charge rate of the high-voltage battery 13 is equal to or higher than the first threshold (for example, the upper limit of full charge), a condition that the temperature of the high-voltage battery 13 is equal to or higher than the second threshold (for example, the temperature of the charge continuation limit), or the like.

If the high-voltage battery 13 is ready to charge power (step S202, no), the process proceeds S203 the step. On the other hand, if the high-voltage battery 13 is not able to charge power (step S202, Yes), the process proceeds to step S204.

### S203 of Steps

The power output control unit 12 sets (switches) the output destination of the power generated by the solar panel 11 to the high-voltage battery 13. The power output control unit 12 executes control to charge the power generated by the solar panel 11 to the high-voltage battery 13. With this control, the generated power of the solar panel 11 is stored in the high-voltage battery 13 without waste. When the charge control to the high-voltage battery 13 using the generated power of the solar panel 11 is performed, the process proceeds S205 steps.

S204 of Steps

The power output control unit 12 sets (switches) the output destination of the power generated by the solar panel 11 to the outer-vehicle facility 20. The power output control unit 12 executes control for outputting (supplying) electric power generated by the solar panel 11 to the outer-vehicle facility 20. By this control, the generated power of the solar panel 11 is provided to the outer-vehicle facility 20. The following four approaches can be exemplified for the method of outputting (supplying) the electric power generated by the solar panel 11 to the outer-vehicle facility 20.

Method 1-1: Automatic Output

When it is determined that the high-voltage battery 13 is in a state in which it is impossible to charge the power, the power output control unit 12 is a method of automatically outputting the power generated by the solar panel 11 to the outer-vehicle facility 20.

Method 1-2: Output in Response to User's Answer

When it is determined that the high-voltage battery 13 is in a state in which it is impossible to charge the power, the power output control unit 12 inquires to the user or the like. Then, after receiving the answer (instruction) to the inquiry from the user or the like, the power output control unit 12 is a method of outputting the power generated by the solar panel 11 to the outer-vehicle facility 20.

Methodology 1-3: Output According to a Specified Schedule

When it is determined that the high-voltage battery 13 is in a state in which it is impossible to charge the electric power, and when there is a preset schedule relating to the output to the outer-vehicle facility 20 from the user of the vehicle or the like, the power output control unit 12 outputs the electric power generated by the solar panel 11 to the outer-vehicle facility 20 in accordance with this schedule. This method 1-3 differs from the method 1-1 in that the output of power is performed intermittently on the basis of a specified schedule.

Method 1-4: Output to Minimize Power Cost

When it is determined that the high-voltage battery 13 is in a state in which it is impossible to charge the power, a method of outputting the generated power of the solar panel 11 so that the power cost in the outer-vehicle facility 20 is minimized. For example, when the outer-vehicle facility 20 is such as a house, so that the power cost calculated based on the total amount of power supplied from the vehicle to the house and the household power price determined by the power company is minimized, the output of the power is controlled. The power cost may be the product of the total amount of power and the household power price. More specifically, during the daytime when the home power price is high, it consumes the power supplied from the solar panel 11 exclusively, during the nighttime when the home power price is cheap, it uses a large amount of commercial power of the electric power company. Thus, the power output control unit 12 appropriately controls the supply amount and time zone for supplying power to the outer-vehicle facility 20.

When the power output control unit 12 or the like detects that a special situation (emergency situation) requiring electric power such as a power failure has occurred in the outer-vehicle facility 20, the control of immediately outputting (supplying) electric power generated by the solar panel 11 to the outer-vehicle facility 20 may be executed regardless of whether the high-voltage battery 13 is in a state in which electric power can be charged or in a state in which electric power cannot be charged, and regardless of any of the methods described above.

When the charge control to the outer-vehicle facility 20 using the generated power of the solar panel 11 is performed, the process proceeds S205 steps.

S205 of Steps

The power output control unit 12 instructs the notification unit 16 to notify the user of the vehicle or the like of the state of the charge control indicating whether the power generated by the solar panel 11 is output to the high-voltage battery 13 or to the outer-vehicle facility 20. Further, the power output control unit 12, so as to notify the user or the like of the vehicle such as the power cost and cost reduction effect in the outer-vehicle facility 20, an instruction is given to the notification unit 16. This notification is not essential and may be omitted. In addition, with respect to the notification of the power cost, the cost reduction effect, and the like, the timing of the notification and the content of the notification (the previous actual result, the accumulated value up to now, and the like) can be set arbitrarily. When notifications such as the status of the charge control by the vehicle and the power cost of the outer-vehicle facility 20 is performed, the process proceeds S201 steps.

In the power output control of this first example, when the high-voltage battery 13 is in a state where it is impossible to charge power, the power generated by the solar panel 11 is output (supplied) to the outer-vehicle facility 20. With this control, the power generated by the solar panel 11 can be effectively utilized.

2. Power Output Control of the Second Example

Power output control process of the second example shown in FIG. 3 is executed when the vehicle power control device 10 (vehicle) is a state (V2H connection state) which is connected to the outer-vehicle facility 20 and the power supply possible. S301 of steps

The power output control unit 12 determines whether or not the solar panel 11 is generating electric power that can be charged. The electric power that can be charged is as described in the first example. If the solar panel 11 is generating power that can be charged (step S301, Yes), the process proceeds to step S302. On the other hand, if the solar panel 11 is not generating power that can be charged (step S301, no), the determination of the step S301 is repeated until the rechargeable power is generated.

### S302 of Steps

The power output control unit 12 determines whether or not the high-voltage battery 13 satisfies a predetermined condition, that is, whether or not the high-voltage battery 13 is in a state in which it is impossible to charge power. The state in which it is impossible to charge the high-voltage battery 13 with electric power and the predetermined conditions are as described in the first example. If the high-voltage battery 13 is ready to charge power (step S302, no), the process proceeds S303 the step. On the other hand, if the high-voltage battery 13 is not able to charge power (step S302, Yes), the process proceeds to step S304. S303 of steps

The power output control unit 12 sets (switches) the output destination of the power generated by the solar panel 11 to the high-voltage battery 13 and executes control to charge the power generated by the solar panel 11 to the high-voltage battery 13. With this control, the generated power of the solar panel 11 is stored in the high-voltage battery 13 without waste. When the charge control to the high-voltage battery 13 using the generated power of the solar panel 11 is performed, the process proceeds S305 steps.

### S304 of Steps

The power output control unit 12 sets (switches) the output destination of the power generated by the solar panel 11 to the outer-vehicle facility 20 and the auxiliary battery 14. The power output control unit 12 executes control for outputting (supplying) electric power generated by the solar panel 11 to the outer-vehicle facility 20 and the auxiliary battery 14. By this control, the generated power of the solar panel 11 is provided to both the vehicle outer-vehicle facility 20 and the auxiliary battery 14. The following four approaches can be exemplified for the method of outputting (supplying) the electric power generated by the solar panel 11 to the outer-vehicle facility 20.

Method 2-1: Automatic Output

When it is determined that the high-voltage battery 13 is in a state in which it is impossible to charge the power, the power output control unit 12 automatically outputs the power generated by the solar panel 11 to the outer-vehicle facility 20 and the auxiliary battery 14.

Method 2-2: Output in Response to User's Answer

When it is determined that the high-voltage battery 13 is in a state in which it is impossible to charge the power, the power output control unit 12 inquires to the user or the like. Then, after receiving the answer (instruction) to the inquiry from the user or the like, the power output control unit 12 is a method of outputting the power generated by the solar panel 11 to one or both of the outer-vehicle facility 20 and the auxiliary battery 14.

Method 2-3: Output According to the Specified Schedule

When it is determined that the high-voltage battery 13 is in a state in which it is impossible to charge the electric power, and when there is a preset schedule relating to the output to the outer-vehicle facility 20 from the user of the vehicle or the like, or to the vehicle, the power output control unit 12 outputs the electric power generated by the solar panel 11 to one or both of the outer-vehicle facility 20 and the auxiliary battery 14 in accordance with this schedule. This method 2-3 performs power output intermittently based on a specified schedule compared to the above method 2-1 in which power output is performed continuously.

Method 2-4: Output to Minimize Power Cost

When it is determined that the high-voltage battery 13 is in a state in which it is impossible to charge the power, a method of outputting the generated power of the solar panel 11 so that the power cost in the outer-vehicle facility 20 is minimized. For example, when the outer-vehicle facility 20 20 is such as a house, so that the power cost calculated based on the total amount of power supplied from the vehicle to the house and the household power price determined by the power company is minimized, the output of power to the outer-vehicle facility 20 is controlled. The power cost may be the product of the total amount of power and the household power price. More specifically, during the daytime when the home power price is high, the power supplied from the solar panel 11 is consumed exclusively (e.g., limiting the output to the auxiliary battery 14), during the nighttime when the home power price is low, to use a large amount of commercial power of the electric power company (e.g., giving priority to the output to the auxiliary battery 14), and the like, the power output control unit 12 appropriately controls the amount and time period for supplying power to the outer-vehicle facility 20 and the auxiliary battery 14.

When the power output control unit 12 or the like detects that a special situation (emergency situation) requiring electric power such as a power failure has occurred in the outer-vehicle facility 20, the control of immediately outputting (supplying) electric power generated by the solar panel 11 to the outer-vehicle facility 20 and the auxiliary battery 14 may be executed regardless of whether the high-voltage battery 13 is in a state in which electric power can be charged or in a state in which electric power cannot be charged, and regardless of any of the methods described above.

Further, prior to performing the process of the above-described stepped S304, such as the power output control unit 12, the auxiliary battery 14 may be further determined whether or not it is impossible to charge the power state (such as a full charge state). In this determination, if the auxiliary battery 14 is in a state where it is impossible to charge the power, the output destination of the power generated by the solar panel 11 may be set only to the outer-vehicle facility 20.

When the charge control to the outer-vehicle facility 20 and the auxiliary battery 14 using the generated power of the solar panel 11 is performed, the process proceeds S305 steps.

S305 of Steps

The power output control unit 12 instructs the notification unit 16 to notify the user of the vehicle or the like of the state of the charge control indicating whether the power generated by the solar panel 11 is output to the high-voltage battery 13 or to the outer-vehicle facility 20 and the auxiliary battery 14. Further, the power output control unit 12, so as to notify the user or the like of the vehicle such as the power cost and cost reduction effect in the outer-vehicle facility 20, an instruction is given to the notification unit 16. This notification is as described in the first example above. When notifications such as the status of the charge control by the vehicle and the power cost of the outer-vehicle facility 20 is performed, the process proceeds S301 steps.

In the power output control of this second example, when the high-voltage battery 13 is in a state where it is impossible to charge power, the power generated by the solar panel 11 is output (supplied) to one or both of the outer-vehicle facility 20 and the auxiliary battery 14. With this control, the power generated by the solar panel 11 can be more effectively utilized than the first example described above.

Effects

As described above, according to the vehicle power control device 10 according to an embodiment of the present disclosure, when the high-voltage battery 13 is in a state in which it is impossible to charge the power, the output destination of the power generated by the solar panel 11 is set to the outer-vehicle facility 20, and the power generated by the solar panel 11 is output to only the outer-vehicle facility 20. Alternatively, the output destination of the electric power generated by the solar panel 11 is set to the outer-vehicle facility 20 and the auxiliary battery 14, and output to one or both of the outer-vehicle facility 20 and the auxiliary battery 14.

By this control, the vehicle power control device 10 according to the present embodiment, it is possible to effectively utilize the power generated by the solar panel 11.

While one embodiment of the disclosed technology has been described above, the present disclosure can be viewed not only as a power control device, but also as a power control method performed by the power control device, a program of the power control method, a computer-readable non-temporary storage medium storing the program, a vehicle equipped with a power control device, and the like.

The power control device of the present disclosure is available for vehicles and the like that utilize power generated by solar panels.

What is claimed is:

1. A vehicle power control device comprising:
a solar panel;
a first battery that is able to charge power generated by the solar panel; and
a power output control unit that controls an output destination of the power generated by the solar panel to either the first battery or an outside of a vehicle.

2. The vehicle power control device according to claim 1, wherein when the first battery satisfies a predetermined condition, the power output control unit outputs the power generated by the solar panel to the outside of the vehicle.

3. The vehicle power control device according to claim 1, further comprising a second battery that is able to charge the power generated by the solar panel,
wherein when the first battery satisfies a predetermined condition, the power output control unit outputs the power generated by the solar panel to the outside of the vehicle and the second battery.

4. The vehicle power control device according to claim 2, wherein the predetermined condition is that a storage rate of the first battery is equal to or higher than a first threshold.

5. The vehicle power control device according to claim 2, wherein the predetermined condition is that a temperature of the first battery is equal to or higher than a second threshold.

6. A power control method executed by a vehicle power control device including a solar panel, a first battery that is able to charge power generated by the solar panel, and a power output control unit that controls an output destination of the power generated by the solar panel to either the first battery or an outside of a vehicle, the power control method comprising
outputting the power generated by the solar panel to the outside of the vehicle via the power output control unit when the first battery satisfies a predetermined condition.

7. A vehicle on which the vehicle power control device according to claim 1 is mounted.
